(19) United States
(12) Patent Application Publication
(10) Pub. No.: US 2007/0054094 A1
(43) Pub. Date: Mar. 8, 2007

(54) Multi-layer material with three dimensional texture

(76) Inventors: Fu Shen Chen, Tianwei Township (TW); Yung Ming Tsai, Taichung City (TW); Ming Liang Wu, Mingjian Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/269,527

(22) Filed: Nov. 9, 2005

(30) Foreign Application Priority Data
Sep. 8, 2005 (TW) 094130962

(51) Int. Cl. B32B 3/00

(52) U.S. Cl. 428/172

(57) ABSTRACT

A multi-layer material comprises a multi-layer substrate as a core. The multi-layer substrate mainly comprises a PET film, an aluminum layer, an EVA adhesive layer and a PET plate. The aluminum layer is formed on the PET film, the EVA adhesive layer is subsequently formed on the aluminum layer, and the PET plate is finally formed on the EVA adhesive layer. The PET film is imprinted with a plurality of convex sections and a plurality of concave sections that form into a three-dimensional texture. Accordingly, the aluminum layer forms with convexes and concaves, corresponding to the convex sections and concave sections of the PET film. The EVA adhesive layer is provided for preventing the convexes from deformation.

### TECHNICAL FIELD

This invention relates to technology for forming a three-dimensional texture on an article and applications of PET, PU, EVA and aluminum materials.

### BACKGROUND OF THE INVENTION

A leather piece disclosed in Taiwan Patent Publication No. 584065, a three-dimensional picture disclosed in Taiwan Patent Publication No. M 248633, and a reflective fabric disclosed in Taiwan Patent Publication No. M 255150 relate to applications of special reflection layers or refraction layers to create effects of three-dimensional patterns; however, the patterns observed do not have three-dimensional textures.

Furthermore, Taiwan Patent Publication No. 403639 indicates a method to form a cubic sign. Although the cubic sign has a three-dimensional pattern, an outlook of a desired pattern must firstly be screen-printed on a substrate. The printed substrate is then imprinted by a zinc plate, which is pre-formed with a corresponding pattern, so the cubic sign is embossed. Additionally, the method requires precise positioning during imprinting, and the printed pattern is exposed to outside that is prone to suffer from abrasion and oxidization.

### SUMMARY OF INVENTION

It is therefore an object of the present invention to provide a multi-layer material with a three-dimensional texture, which could be patterns, characters or a blend of patterns and characters.

More particularly, the multi-layer material comprises a multi-layer substrate as a core of the multi-layer material. The multi-layer substrate mainly comprises a PET film, an aluminum layer, an EVA adhesive layer and a PET plate. The aluminum layer is formed on the PET film, which is served as a top layer of the multi-layer substrate, the EVA adhesive layer is subsequently formed on the aluminum layer, and the PET plate, served as a bottom layer of the multi-layer substrate, is finally formed on the EVA adhesive layer. Additionally, the PET film is transparent and is imprinted with a plurality of convex sections and a plurality of concave sections that form into the three-dimensional texture. Accordingly, the aluminum layer forms with convexes and concaves, corresponding to the convex sections and concave sections of the PET film. During imprinting processes, heat and pressure cause the melt EVA adhesive layer to develop into the layer with different thicknesses corresponding the convexes and the concaves. In other words, the melt EVA adhesive layer is thicker at the area corresponding to the convexes of the aluminum layer and is thinner at the area corresponding to the concaves of the aluminum layer after cooling. Thus, the EVA adhesive layer formed and bonded between the aluminum layer and the PET plate prevents the convexes from deformation.

In comparison with the conventional technology, the present invention directly embosses the three-dimensional texture without pre-printing, aligning and embossing patterns on the substrate. Furthermore, the aluminum layer provides metallic nature and effect that not only enhances the structure of the three-dimensional texture, but also provides the distinctive metallic quality of the multi-layer material. More importantly, due to the support from the EVA adhesive layer, the height of the convex sections of the three-dimensional texture can be increased, and the convex sections would not be deformed easily.

In one preferred embodiment of the present invention, the multi-layer material further comprises a PU base plate, a colored layer and a PU protective layer. A top of the PU base plate has a frame, which is provided for receiving the multi-layer substrate. The colored layer is formed by filling the concave sections of the PET film of the multi-layer substrate with color pigments selectively, so as to color the multi-layer material. The PU protective layer is transparent and is formed on the frame to cover the multi-layer substrate, so as to protect the colored layer.

### BRIEF DESCRIPTION OF DRAWINGS

The invention will be more clearly understood after referring to the following detailed description read in conjunction with the drawings wherein:

FIG. 1 is a cross sectional view of a first embodiment of the present invention, showing a PET film formed on an aluminum layer;

FIG. 2 is a cross sectional view of the first embodiment of the present invention, showing an EVA adhesive layer formed on a PET plate;

FIG. 3 is a cross-sectional view of the first embodiment of the present invention, showing a multi-layer substrate comprising the PET film, the aluminum layer, the EVA adhesive layer and the PET plate shown in FIG. 1 and FIG. 2;

FIG. 4 is an enlarged cross sectional view of the first embodiment of the present invention, showing the PET film formed with a plurality of convex sections and a plurality of concave sections;

FIG. 5 is a schematic view, showing the PET film of the multi-layer substrate forming with antioxidant;

FIG. 6 is a schematic view, showing the PET film and the aluminum layer of the multi-layer substrate forming with a first ground color and a second ground color respectively;

FIG. 7 is a perspective view of a stethoscope product, showing the multi-layer substrate being applied to the stethoscope product;

FIG. 8 is a cross sectional view of a second embodiment of the present invention, showing a multi-layer material comprising a multi-layer substrate, a PU protective layer and a fibrous layer;

FIG. 9 is a cross sectional view of a third embodiment of the present invention, showing a multi-layer material comprising a multi-layer substrate, a PU protective layer, a colored layer and a fibrous layer;

FIG. 10 is a cross sectional view of a fourth embodiment of the present invention, showing a multi-layer material comprising a multi-layer substrate, a PU base plate, a PU protective layer and a fibrous layer; and

FIG. 11 is a cross sectional view of a fifth embodiment of the present invention, showing a multi-layer material comprising two multi-layer substrates, a double-side PU base plate and two PU protective layers.

### DETAILED DESCRIPTION OF THE EMBODIMENTS

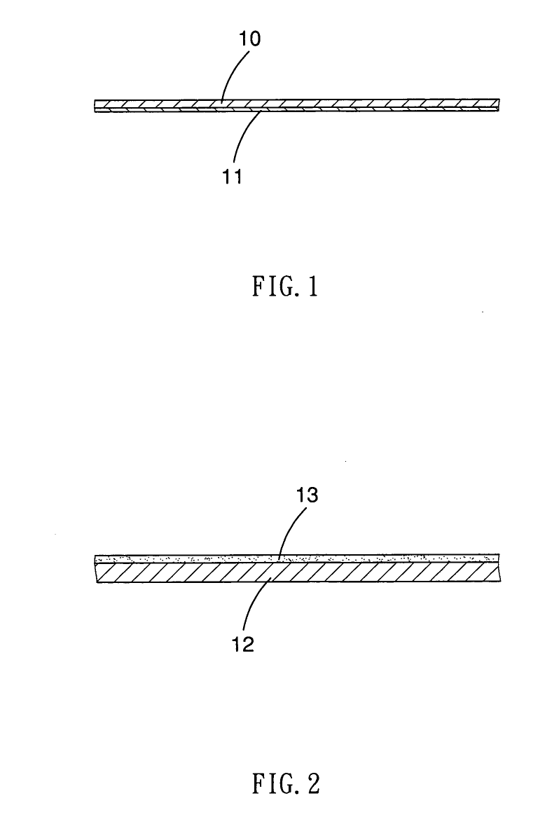

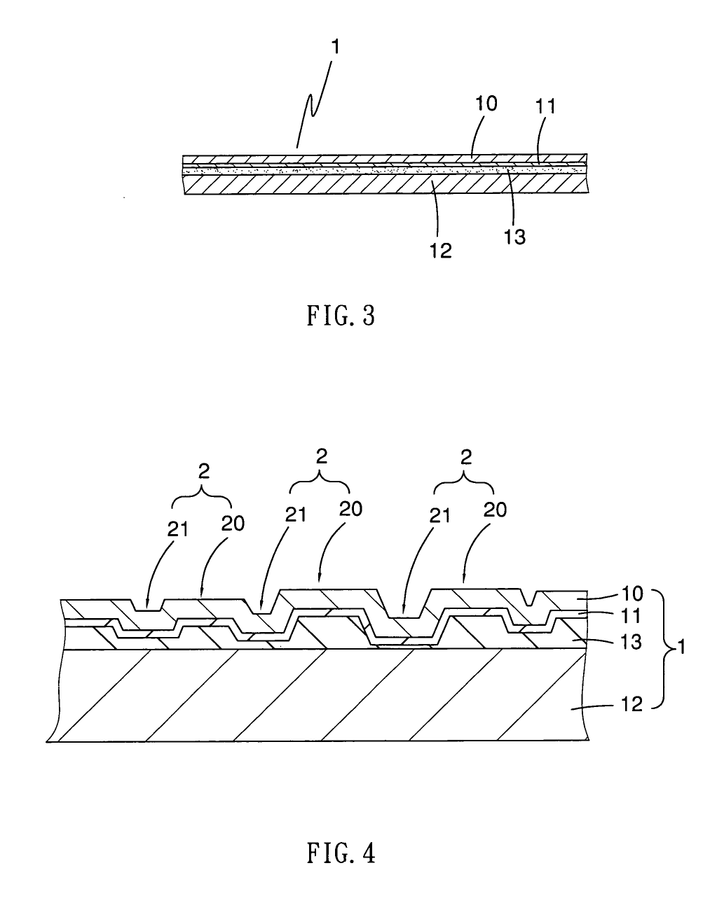

The present invention discloses a multi-layer material, which mainly comprises a multi-layer substrate 1, and FIGS. 1-6 show the multi-layer substrate 1 as a first embodiment of the present invention. In FIG. 1, an aluminum layer 11 is formed on and bonded to a bottom of a Polyethylene Terephthalate (PET) film 10. Additionally, FIG. 2 shows an Ethyl Vinyl Acetate (EVA) adhesive layer 13 is formed on a top of a PET plate 12. FIG. 3 shows the PET film 10, the aluminum layer 11, the EVA adhesive layer 13 and the PET plate 12 shown in FIG. 1 and FIG. 2 are laminated and bonded to each other so as to form into the multi-layer substrate 1.

In the present invention, the PET film 10 of the multi-layer substrate 1 is served as a top layer of the multi-layer substrate 1 and can be replaced by other similar plastic material. The PET film 10 can be either transparent or semi-transparent. The aluminum layer 11 is formed on and bonded to the bottom of the PET film 10 via aluminum electroplating, and provides a platinum-colored luster effect. Other metals can be used to substitute the aluminum, such as gold, silver or copper, if a different color effect is required.

Additionally, The PET plate 12 is served as a bottom layer of the multi-layer substrate 1 and has a thickness greater than the PET film 10. Preferably, the PET plate 12 has the thickness in a range of 80 to 200 μm and the PET film 10 has a thickness in a range of 12 to 23 μm. The EVA adhesive layer 13 is formed between the aluminum layer 11 and the PET plate 12, and is served as a thermo-bond material so as to bond the aluminum layer 11 and the PET plate 12 together firmly.

FIG. 4 shows the PET film 10 of the multi-layer substrate 1 formed with a plurality of convex sections 20 and a plurality of concave sections 21 that form into three-dimensional textures 2. The convex sections 20 and the concave sections 21 of the three-dimensional textures 2 are imprinted on the PET film 10. Accordingly, the aluminum layer 11 is formed with convexes and concaves, corresponding to the convex sections 20 and concave sections 21 formed on the PET film 10. During imprinting processes, heat and pressure cause the melt EVA adhesive layer 13 to be pressed and to develop into the layer with different thicknesses corresponding the convexes and the concaves. In other words, the pressed EVA adhesive layer 13 is thicker at the area corresponding to the convexes of the aluminum layer 11 and is thinner at the area corresponding to the concaves of the aluminum layer 1 after cooling. Thus, the EVA adhesive layer 13 formed and bonded between the aluminum layer 11 and the PET plate 12 prevents the convex sections 20 of the three-dimensional textures 2 from deformation.

Because the three-dimensional textures 2 are directly imprinted on the multi-layer substrate 1, it is not necessary for flat patterns to be firstly printed, and followed by aligning and embossing the three-dimensional textures 2. Furthermore, with the metallic face that is provided by the aluminum layer 10 as a ground, it not only enhances the three-dimensional effect and structures of the three-dimensional textures 2, but also provides distinctive metallic quality. More importantly, due to the support of the EVA adhesive layer 13, the convex sections 20 of the three-dimensional textures 2 are stronger that allow the height of the convex sections 20 to be increased. By controlling the thicknesses of the PET film 10 and the EVA adhesive layer 13, the heights of the convex sections 20 are easily determined. The higher the convex sections 20, the better the three-dimensional effect will be presented.

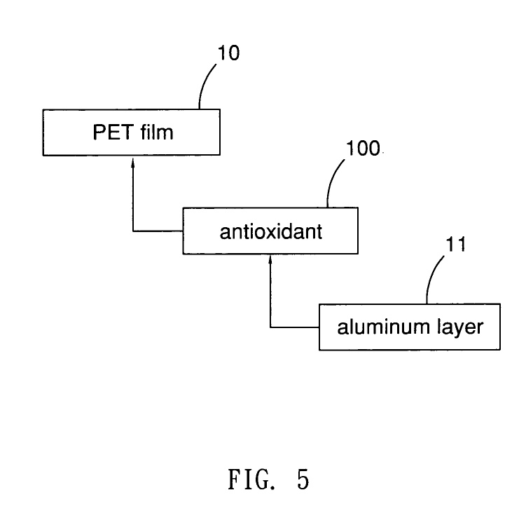

FIG. 5 shows a layer of antioxidant 100 is firstly applied to the bottom of the PET film 10, followed by electroplating so as to form the aluminum layer 11. Under this circumstance, the PET film 10 with the antioxidant 100 protects the aluminum layer 11 from oxidization and provides a lasting glossy effect.

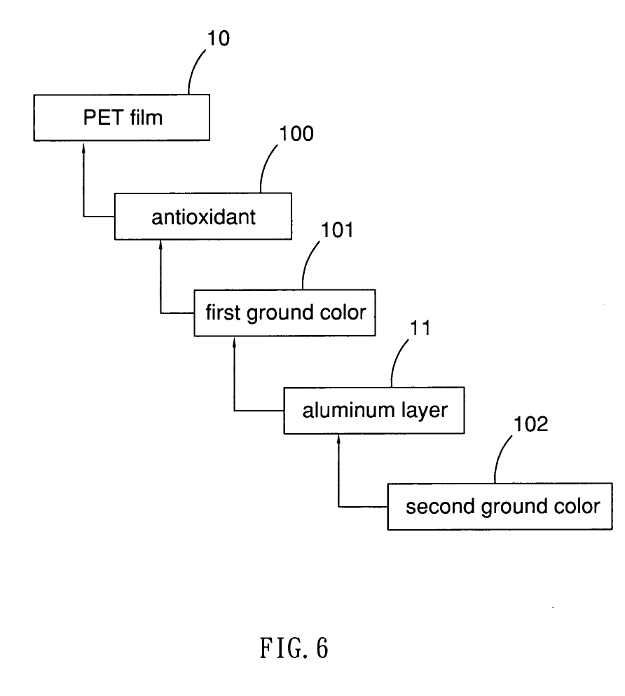

In FIG. 6, a layer of antioxidant 100 is firstly applied to the bottom of the PET film 10, followed by applying a first ground color 101, and then electroplating to form the aluminum layer 11, and finally applying a second ground color 102. The first ground color 101 and the second ground color 102 are of the same colors, and are both transparent and penetrating. Therefore, the aluminum layer 11 is able to provide different color effects based on the color selection of the first ground color 100 and the second is ground color 102. For example, if the first ground color 100 and the second ground color 102 are yellow, the aluminum layer 11 provides a yellow luster effect.

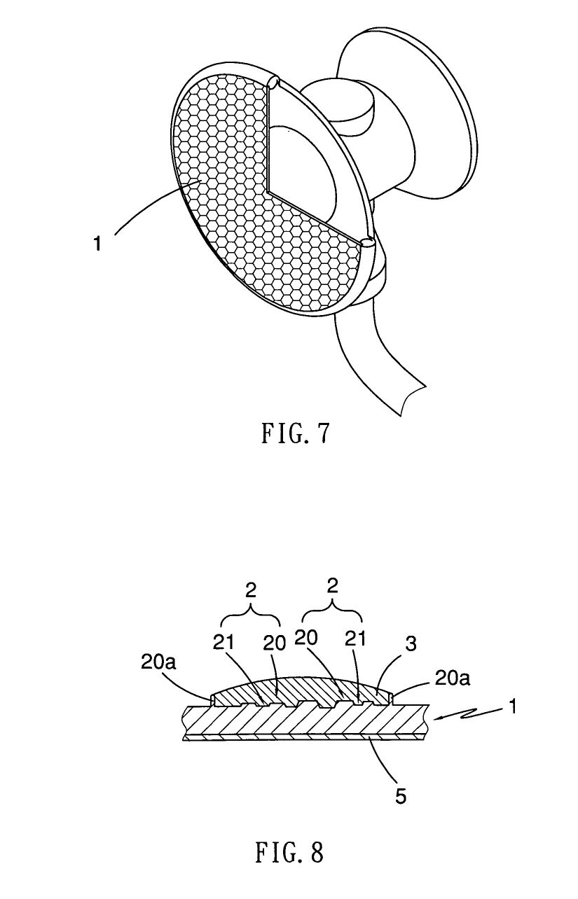

According to above descriptions, the multi-layer substrate 1 of the multi-layer material can be used directly for making name cards, pictures, cards, and labels etc. In particular, the multi-layer substrate 1 can be further used as a diaphragm for a stethoscope, as shown in FIG. 7. Because a bottom of the PET plate 12 is flat that enables additional layers to be easily added to the bottom of the multi-layer substrate 1, such as a PU base plate or a fibrous layer that will be described subsequently. In addition, the multi-layer substrate 1 of the present invention can further be attached to a frame or a rubber magnet sheet to form a personal accessory or a key chain and the like that would be a further application to the present invention.

In FIG. 8, a second embodiment of the present invention is shown, which comprises a PU protective layer 3, a fibrous layer 5, and the multi-layer substrate 1. The PU protective layer 3 is provided for covering the multi-layer substrate 1 and is transparent or semi-transparent. The convex sections 20 and the concave sections 21 of the three-dimensional textures 2 are protected by and visible from the PU protective layer 3. Additionally, as shown in FIG. 8, one of the convex sections 20 forms a frame 20a and the rest of the convex sections 20 and the concave sections 21 form a main pattern, such as a trademark within the frame 20a.

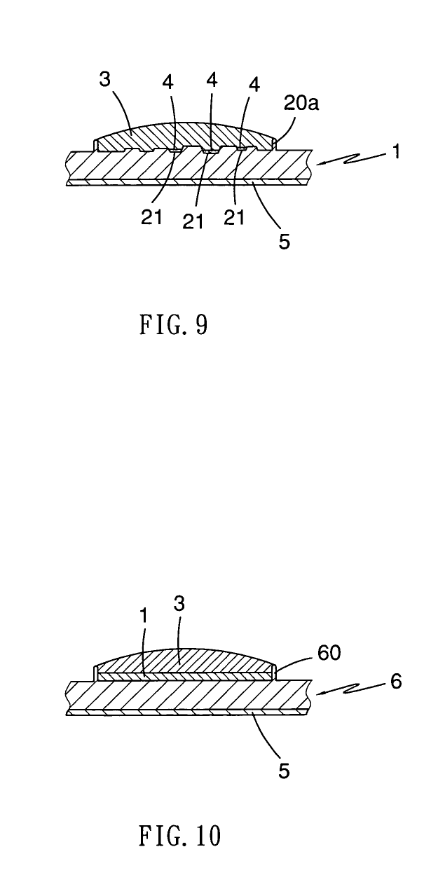

FIG. 9 further shows a third embodiment of the present invention, which comprises the PU protective layer 3, the fibrous layer 5, the multi-layer substrate 1 similarly to the second embodiment but further comprises a colored layer 4. The colored layer 4 is formed by filling the concave sections 21 with pigments selectively. Preferably, the pigments are resin inks and transparent, semi-transparent or opaque. Accordingly, the three-dimensional textures present colorful effects.

In FIG. 8 and FIG. 9, the outside of the frame 20a can be used as stitching sections, so as to be stitched onto shoes, clothes or socks. Furthermore, to ensure that the stitching sections can be secured on the stitched object, glue can be applied to attach a fibrous layer 5 onto the bottom of the multi-layer substrate 1, namely the bottom of the PET plate. The fibrous layer 5 contains some mutually intertwined long fibers, such as the Super-Tuff manufactured by the Dupont Company.

FIG. 10 shows a fourth embodiment of the present invention, which comprises the PU protective layer 3, the fibrous layer 5, the multi-layer substrate 1 as a core to the multi-layer material, similarly to the foregoing embodiments but further comprises a PU base plate 6. In comparison with the PU protective layer 3, the PU base plate 6 is produced under relatively higher temperature conditions, and has a frame 60 protruding from a top of the PU base plate 6. The frame 60 is provided for receiving the multi-layer substrate 1, and the PET film of the multi-layer substrate 1 faces an entry of the frame 60 when the multi-layer substrate 1 is received within the frame 60. The PU protective layer 3 is formed on and bonded to the frame 60, so as to cover the multi-layer substrate 1. To enhance the bonding connection between the multi-layer substrate 1 and the PU base plate 6, a liquid PU material can be applied onto the interfaces between the multi-layer substrate 1 and the PU base plate 6. After the liquid PU material dries up, the multi-layer substrate 1 and the PU base plate 6 are tightly bonded together. Additionally, to further provide a color effect, a colored layer can first be formed on the multi-layer substrate 1 (not shown) similarly to the above embodiments, and then followed by forming the PU protective layer 3.

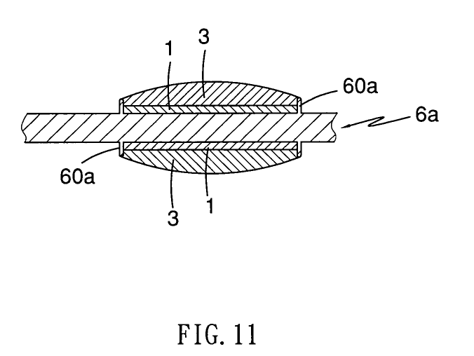

A fifth embodiment of the present invention is shown in FIG. 11, which comprises two PU protective layers 3 and two multi-layer substrates 1, similarly to the foregoing embodiments but further comprises a double-side PU base plate 6a. The double-side PU base plate 6a has two frames 60a respectively protruding from a top and a bottom of the double-side PU base plate 6a. Each of the frames 60a is provided for receiving one of the multi-layer substrates 1, and the PET film of each of the multi-layer substrates 1 faces an entry of each of the frames 60a when the multi-layer substrates 1 are received within the two frames 60a respectively. Similarly to the fourth embodiment, the PU protective layers 3 are formed on and bonded to the frames 60a, so as to cover the multi-layer substrates 1 respectively. In the fifth embodiment, the application of the double-side PU base plate 6a can be used to make pendants, which have double-side patterns.

Nevertheless, each layer in the foregoing embodiments does not make use of any hard and inflexible materials. Therefore, the embodiments of the present invention allow for a certain degree of tortuosity, and there will not be changes in shape even if used on clothes that need to be washed often, or on other products that often need to be bent.

What is claimed is:

1. A multi-layer material, comprising:
a multi-layer substrate, comprising:
a PET film, formed with a plurality of convex sections and a plurality of concave sections, wherein the PET film is transparent and the plurality of convex sections and the plurality of concave sections together form into a three-dimensional texture;
an aluminum layer, formed on a bottom of the PET film, and formed with convexes and concaves according to the plurality of convex sections and the plurality of concave sections of the PET film;
an EVA adhesive layer, formed on a bottom of the aluminum layer, wherein the EVA adhesive layer is thicker at the area corresponding to the convexes of the aluminum layer and is thinner at the area corresponding to the concaves of the aluminum layer; and
a PET plate, formed on the EVA adhesive layer.

2. The multi-layer material of claim 1, wherein the bottom of the PET film of the multi-layer substrate has an antioxidant.

3. The multi-layer material of claim 1, wherein:
the bottom of the PET film of the multi-layer substrate has an antioxidant and a first ground color; and
the bottom of the aluminum layer of the multi-layer substrate has a second ground color, which is the same color as the first ground color.

4. The multi-layer material of claim 2, further comprising a PU protective layer, formed on a top of the PET film of the multi-layer substrate, wherein the PU protective layer is transparent.

5. The multi-layer material of claim 1, further comprising:
a colored layer, formed by filling the plurality of concave sections of the PET film with pigments selectively; and
a PU protective layer, formed on the PET film of the multi-layer substrate and covering the colored layer, wherein the PU protective layer is transparent.

6. The multi-layer material of claim 1, wherein one of the plurality of convex sections of the PET film forms a frame, and the rest of the plurality of convex sections and the plurality of concave sections of the PET film form a main pattern within the frame.

7. The multi-layer material of claim 6, further comprising a PU protective layer, formed on the frame and covering the main pattern, wherein the PU protective layer is transparent.

8. The multi-layer material of claim 6, further comprising:
a colored layer, formed by filling the plurality of concave sections of the PET film with pigments selectively; and
a PU protective layer, formed on the frame and covering the main pattern, wherein the PU protective layer is transparent.

9. The multi-layer material of claim 4, further comprising a fibrous layer, formed on a bottom of the PET plate of the multi-layer substrate.

10. The multi-layer material of claim 5, further comprising a fibrous layer, formed on a bottom of the PET plate of the multi-layer substrate.

11. The multi-layer material of claim 7, further comprising a fibrous layer, formed on a bottom of the PET plate of the multi-layer substrate.

12. The multi-layer material of claim 8, further comprising a fibrous layer, formed on a bottom of the PET plate of the multi-layer substrate.

13. The multi-layer material of claim 1, further comprising:
a PU base plate, having a frame protruding from a top of the PU base plate for receiving the multi-layer substrate, wherein the PET film of the multi-layer substrate faces an entry of the frame when the multi-layer substrate is received within the frame; and
a PU protective layer, formed on the frame and covering the multi-layer substrate, wherein the PU protective layer is transparent.

14. The multi-layer material of claim 13, wherein the PU base plate has fibers mixed therein.

15. The multi-layer material of claim 13, further comprising a fibrous layer, formed on a bottom of the PU base plate.

16. The multi-layer material of claim 1, further comprising:
a colored layer, formed by filling the plurality of concave sections of the PET film with pigments selectively;
a PU base plate, having a frame protruding from a top of the PU base plate for receiving the multi-layer substrate, wherein the PET film faces an entry of the frame when the multi-layer substrate is received within the frame; and
a PU protective layer, formed on the frame and covering the multi-layer substrate, wherein the PU protective layer is transparent.

17. The multi-layer material of claim 16, wherein the PU base plate has fibers mixed therein.

18. The multi-layer material of claim 16, further comprising a fibrous layer, formed on a bottom of the PU base plate.

19. A multi-layer material, comprising:
two multi-layer substrates, each of the two multi-layer substrates comprising:
a PET film, formed with a plurality of convex sections and a plurality of concave sections, wherein the PET film is transparent and the plurality of convex sections and the plurality of concave sections together form into a three-dimensional texture;
an aluminum layer, formed on a bottom of the PET film, and formed with convexes and concaves according to the plurality of convex sections and the plurality of concave sections of the PET film;
an EVA adhesive layer, formed on a bottom of the aluminum layer, wherein the EVA adhesive layer is thicker at the area corresponding to the convexes of the aluminum layer and is thinner at the area corresponding to the concaves of the aluminum layer; and
a PET plate, formed on the EVA adhesive layer; and
a double-side PU base plate, having two frames respectively protruding from a top and a bottom of the double-side PU base plate, each of the two frames provided for receiving one of the two multi-layer substrates, wherein each PET film of the two multi-layer substrates faces an entry of each of the two frames when the two multi-layer substrates are received within the two frames respectively; and
two PU protective layers, formed on the two frames and covering the two multi-layer substrates respectively, wherein the two PU protective layers are transparent.

20. A multi-layer material, comprising:
two multi-layer substrates, each of the two multi-layer substrates comprising:
a PET film, formed with a plurality of convex sections and a plurality of concave sections, wherein the PET film is transparent and the plurality of convex sections and the plurality of concave sections together form into a three-dimensional texture;
an aluminum layer, formed on a bottom of the PET film, and formed with convexes and concaves according to the plurality of convex sections and the plurality of concave sections of the PET film;
an EVA adhesive layer, formed on a bottom of the aluminum layer, wherein the EVA adhesive layer is thicker at the area corresponding to the convexes of the aluminum layer and is thinner at the area corresponding to the concaves of the aluminum layer; and
a PET plate, formed on the EVA adhesive layer; and
a double-side PU base plate, having two frames respectively protruding from a top and a bottom of the double-side PU base plate, each of the two frames provided for receiving one of the two multi-layer substrates, wherein each PET film of the two multi-layer substrates faces an entry of each of the two frames when the two multi-layer substrates are received within the two frames respectively;
two colored layers, each of the two colored layers being formed by filling the plurality of concave sections of the PET film of each of the two multi-layer substrates with pigments selectively; and
two PU protective layers, formed on the two frames and covering the two colored layers respectively, wherein the two PU protective layers are transparent.
